(19) United States
(12) Patent Application Publication
(10) Pub. No.: US 2014/0289163 A1
(43) Pub. Date: Sep. 25, 2014

(54) Method and Computer Program for Minimizing Trading Costs Subject to a Probability Criterion of Optimality Acceptability

(71) Applicant: New Frontier Advisors, LLP, Boston, MA (US)

(72) Inventors: Robert Michaud, Boston, MA (US); Richard O. Michaud, Boston, MA (US); David N. Esch, Boston, MA (US)

(73) Assignee: New Frontier Advisors, LLP, Boston, MA (US)

(21) Appl. No.: 14/216,266

(22) Filed: Mar. 17, 2014

Related U.S. Application Data
(60) Provisional application No. 61/800,811, filed on Mar. 15, 2013.

(51) Int. Cl. G06Q 40/06

(52) U.S. Cl. CPC G06Q 40/06
USPC 705/36 R

(57) ABSTRACT

Embodiments model a series of partial trades on an investment portfolio to reduce the optimality discrepancy relative to a target optimal portfolio, and determine whether a partially rebalanced portfolio along the trading path is within a predefined threshold of statistical optimality relative to the target optimal portfolio. Certain embodiments maximize the impact of partial rebalancing of a portfolio by maximizing reduction of an optimality discrepancy while minimizing the trade cost function along the trading path from the initial portfolio toward the target optimal portfolio.

### CROSS-REFERENCE TO RELATED APPLICATION

This application claims the benefit of U.S. Provisional Application No. 61/800,811 filed Mar. 15, 2013 entitled “Method and Computer Program for Minimizing Trading Costs Subject to a Probability Criterion of Optimality Acceptability,” the entire contents of which is incorporated herein in its entirety by reference.

### BACKGROUND

Appropriately rebalancing an investment portfolio is a central problem for asset management in practice. Investors often find when they seek professional advice that their portfolio of investments requires rebalancing to a more optimal allocation. Other common reasons for rebalancing a portfolio include portfolio drift over time, changes in investor risk levels and objectives, alternative market forecasts, and many other considerations that require rebalancing an investment portfolio to a more optimal target portfolio.

Many simple to sophisticated conventional procedures for rebalancing a portfolio are well known in the art of professional management. A common, but often too simple, approach is to buy and sell assets relative to replication of the recommended allocations. This approach ignores the impact of trade costs and other considerations on limiting portfolio value. A somewhat more sophisticated approach includes reducing large overweights and underweights relative to approximating target optimal with respect to a trade cost function estimate. A trade cost function may include taxes, portfolio turnover limitations, satisfaction of various mandates or other considerations external to the optimization process beyond estimates of the actual costs of trades. More sophisticated approaches may use Markowitz mean-variance optimization for reducing tracking error of an investment portfolio relative to a target optimal portfolio, where tracking error consists of a measure of the risk or relative variance of the investment portfolio relative to the target optimal portfolio. Trading criteria used in the rebalancing can also be based on mean-variance estimates if they are available for all of the assets, for a contributed portfolio of external securities, to trade incrementally into the new portfolio. However, conventional rebalancing techniques are not capable of and do not determine how much trading is necessary to reduce the distance in portfolio space of a given portfolio to a target optimal portfolio in order to consider the rebalanced portfolio statistically similar to the target optimal in order to avoid trading ineffectively.

Michaud, R., Esch, D., Michaud, R., “Portfolio Monitoring In Theory and Practice,” Journal Of Investment Management, 4th Quarter, 2012 (hereafter “the MEM technique”) describes a statistical test for determining whether a currently held portfolio relative to a given optimal portfolio on the Michaud Resampled Efficient Frontier (referred to here interchangeably as a “resampled efficient frontier” or a “Michaud resampled efficient frontier”) requires rebalancing. MEM is a generalization of the probability criterion portfolio rebalancing procedure described in Michaud and Michaud U.S. Pat. No. 6,928,418 and first published in Michaud and Michaud (2002), the entire contents of which are expressly incorporated herein by reference. Details of the Michaud resampled efficient frontier are described in Michaud, R., Michaud, R., “Efficient Asset Management: A Practical Guide to Stock Portfolio Optimization and Asset Allocation,” Oxford University Press, New York, 2008a, 1st ed. 1998, originally published by Harvard Business School Press, Boston, and in Michaud, R., Michaud, R., “Estimation Error and Portfolio Optimization: A Resampling Solution,” Journal of Investment Management, 6(1):8-28, the entire contents of which are expressly incorporated herein by reference.

The MEM technique is a rigorous statistical similarity test for linear inequality and equality constrained portfolios of whether investment portfolios are statistically similar to given optimal portfolios at a given threshold probability level. The MEM test generalizes the earlier Michaud and Michaud procedure by whether or not the test is conditional on a specified rebalancing period that may be associated with an investment strategy (the parameter k in MEM). For example, a value manager may typically trade once or twice a year while a growth stock manager may typically trade many times a year. Rebalancing period may have a significant impact on the threshold level of the MEM rebalancing test as a function of assumed rebalancing period. On the other hand, when no particular investment strategy is considered, the MEM procedure is equivalent to Michaud and Michaud (2002) and in U.S. Pat. No. 6,928,418, the entire contents of which are expressly incorporated herein by reference.

However, the MEM technique does not address how best to rebalance an investment portfolio once the decision to rebalance has been made. A simple approach of rebalancing the portfolio completely to the target optimal portfolio is generally unnecessary from a statistical similarity or economic point of view, even when ignoring a trade cost function. This is because an investment portfolio, that has not been rebalanced completely to the target optimal portfolio, may still be well within the bounds of statistical similarity relative to some threshold level of optimality and a target optimal portfolio on the Michaud resampled efficient frontier.

### SUMMARY

Embodiments model a series of partial trades on an investment portfolio to reduce the optimality discrepancy relative to a target optimal portfolio, and determine whether a partially rebalanced portfolio along the trading path is within a predefined threshold of statistical optimality relative to the target optimal portfolio. That is, embodiments determine whether there is a beneficial stopping point of a partially rebalanced portfolio along the trading path within a predefined threshold of statistical optimality relative to the target optimal portfolio. The partial trades may be modeled based on one or more predefined criteria. The exemplary procedure may also consider a plurality of portfolios on the Michaud resampled efficient frontier for determining whether an investment portfolio may be considered statistically optimal relative to a given threshold rebalance probability level.

Certain embodiments maximize the impact of partial rebalancing of a portfolio by maximizing the reduction of an optimality discrepancy while minimizing the trade cost function along the trading path from the initial portfolio toward the target optimal portfolio.

In accordance with one exemplary embodiment, a computer modeling system is provided for modeling partial trades to rebalance an investment portfolio. The computer modeling system includes a memory having stored thereon computer-executable instructions for modeling one or more partial trades to rebalance an initial investment portfolio. The computer modeling system also includes a processor operatively coupled to the memory and configured to:

programmatically receive, as a first input, a Michaud resampled efficient frontier of portfolios, the Michaud resampled efficient frontier programmatically generated based on input data corresponding to returns of a plurality of asset classes; programmatically receive, as a second input, a first target optimal portfolio on the Michaud resampled efficient frontier of portfolios; programmatically read the computer-executable instructions from the memory to model a first partial trade based on the initial portfolio toward the first target optimal portfolio to generate a first partially rebalanced portfolio, the first partial trade modeled to reduce a first optimality discrepancy associated with the initial portfolio; determine a first rebalance probability associated with the first partially rebalanced portfolio; and determine that the first partially rebalanced portfolio is statistically optimal if the first rebalance probability satisfies a predefined rebalance probability criterion. The computer modeling system also includes a visual display device configured to display an indication that the first partially rebalanced portfolio is statistically optimal.

In accordance with another exemplary embodiment, a computer-implemented method is provided for modeling partial trades to rebalance an investment portfolio. The method includes programmatically receiving, as a first input, an initial investment portfolio comprising a plurality of assets, each asset characterized by a weighting coefficient. The method includes programmatically receiving, as a second input, a Michaud resampled efficient frontier of portfolios, the Michaud resampled efficient frontier programmatically generated based on input data corresponding to returns of a plurality of asset classes. The method includes programmatically receiving, as a third input, a first target optimal portfolio on the Michaud resampled efficient frontier of portfolios. The method also includes programmatically modeling, using a computing device having encoded thereon computer-executable instructions, a first partial trade based on the initial portfolio toward the first target optimal portfolio to generate a first partially rebalanced portfolio. The first partial trade is modeled to reduce a first optimality discrepancy associated with the initial portfolio. The method also includes determining, using the computing device, a first rebalance probability associated with the first partially rebalanced portfolio. The method also includes determining, using the computing device, that the first partially rebalanced portfolio is statistically optimal if the first rebalance probability satisfies a predefined rebalance probability criterion. The method further includes displaying, using a visual display device, an indication that the first partially rebalanced portfolio is statistically optimal.

In accordance with another exemplary embodiment, one or more computer-readable media are provided, the one or more computer-readable media having encoded thereon one or more computer-executable instructions for performing a computer-implemented method for modeling partial trades to rebalance an investment portfolio. The method includes programmatically receiving, as a first input, an initial investment portfolio comprising a plurality of assets, each asset characterized by a weighting coefficient. The method includes programmatically receiving, as a second input, a Michaud resampled efficient frontier of portfolios, the Michaud resampled efficient frontier programmatically generated based on input data corresponding to returns of a plurality of asset classes. The method includes programmatically receiving, as a third input, a first target optimal portfolio on the Michaud resampled efficient frontier of portfolios. The method also includes programmatically modeling, using a computing device having encoded thereon computer-executable instructions, a first partial trade based on the initial portfolio toward the first target optimal portfolio to generate a first partially rebalanced portfolio. The first partial trade is modeled to reduce a first optimality discrepancy associated with the initial portfolio. The method also includes determining, using the computing device, a first rebalance probability associated with the first partially rebalanced portfolio. The method also includes determining, using the computing device, that the first partially rebalanced portfolio is statistically optimal if the first rebalance probability satisfies a predefined rebalance probability criterion. The method further includes displaying, using a visual display device, an indication that the first partially rebalanced portfolio is statistically optimal.

### BRIEF DESCRIPTION OF THE DRAWINGS

The foregoing and other objects, aspects, features and advantages of exemplary embodiments will be more fully understood from the following description when read together with the accompanying drawings, in which:

FIG. 1 is a block diagram of certain exemplary computer-implemented and computer-executable modules of a computer modeling system that may be used to minimize trading costs subject to a probability criterion of optimality acceptability.

FIG. 2 is a flowchart of an exemplary method for partially rebalancing an initial investment portfolio while minimizing the trade cost or turnover.

FIG. 3 is a portfolio composition map showing exemplary partial trades modeled by Step 218 of exemplary embodiments.

FIG. 4 is a graph showing the tracking errors, rebalance probabilities and turnover (trade cost) of the partial trades illustrated in FIG. 3. Exemplary embodiments identify the section of the horizontal axis that falls into the shaded area, i.e., with rebalance probabilities below a predetermined threshold (50% in this example). Exemplary embodiments identify the point at which the rebalance probability curve crosses the predetermined threshold (50% in this example).

FIG. 5 is a portfolio composition map showing exemplary partial trades modeled by Step 218 of exemplary embodiments.

FIG. 6 is a graph showing the tracking errors, rebalance probabilities and turnover (trade cost) of the partial trades illustrated in FIG. 5. Exemplary embodiments identify the section of the horizontal axis that falls into the shaded area, i.e., with rebalance probabilities below a predetermined threshold (50% in this example). Exemplary embodiments identify the point at which the rebalance probability curve crosses the predetermined threshold (50% in this example).

FIG. 7 is a block diagram of an exemplary computing device that may be used to implement exemplary embodiments.

FIG. 8 is a block diagram of an exemplary network environment in which exemplary embodiments may be implemented.

### DETAILED DESCRIPTION

Exemplary methods, systems and devices enable maximizing the impact of partial rebalancing and, in some embodiments, minimizing the trade cost function, while ensuring that the resulting portfolio is statistically optimal relative to a target optimal portfolio or a plurality of target optimal portfolios on a Michaud resampled efficient frontier for a given threshold rebalance probability. There is a region of uncertainty in portfolio space relative to the target optimal portfolio (or a plurality of target optimal portfolios) for a given threshold probability level where an investment portfolio can be considered statistically equivalently optimal relative to the target and where no further trading is desirable or warranted to reduce the distance function between the portfolio and the target. In view of this, exemplary techniques provide a stopping rule where a portfolio is deemed statistically optimal relative to the target, because further trading to the target in order to reduce the distance function would simply be trading in noise and incurring additional trading costs while being indifferent relative to investment performance. It is determined that a resulting portfolio is statistically optimal relative to a target optimal portfolio, if the portfolio passes a rebalance test for a specified threshold level of rebalance probability. If a rebalance probability associated with a given investment portfolio is less than (or less than or equal to) the threshold rebalance probability relative to a target optimal portfolio on the Michaud efficient frontier, then the given portfolio is deemed statistically optimal and may not require further trading even if is not an exact replicant of the target optimal portfolio. Alternatively, if the rebalance probability is above (or equal to or above) the threshold rebalance probability, an investor may wish to consider trading to or toward the target optimal portfolio. Exemplary embodiments represent a useful extension of the rebalance probability, and determines that the trades are effective relative to a statistically optimal zone.

The trading path formed by the effective trades may be determined by a quadratic programming optimization process. However, the quadratic programming process disclosed herein could be generalized to any distance metric in place of tracking error, and the appropriate optimization process for the type of function implied by that metric substituted here for quadratic programming. The use of the rebalance test in determining whether a fully or partially rebalanced portfolio has entered the statistically acceptable trade target zone provides a stopping rule for minimizing the trade cost function that is appropriate for investment purposes while being novel and advantageous. Certain embodiments identify a threshold trade that will bring an investor's portfolio into statistical optimality relative to the target optimal portfolio, while saving costs associated with turnover and/or other trading considerations. In an example embodiment, the method to form a trading path includes a cutoff determined by a rebalancing rule, where the MEM technique may be one of the rebalancing rules used to determine the cutoff. As discussed above, the MEM technique describes a statistical test for determining whether a currently held portfolio relative to a given optimal portfolio on the Michaud Resampled Efficient Frontier requires rebalancing.

Exemplary embodiments are fully integrated with methods of Michaud resampled efficient frontier and the MEM rebalance test, and are designed to create partially or fully rebalanced portfolios that satisfy the appropriate rebalance threshold while minimizing a cost function associated with trading to optimal. The exemplary technique, without the rebalance test, can be extended to any set of trades within assets with available risk and return estimates (even if some of those estimates are 0). Moreover, it is often of interest to know which trades move the portfolio most effectively towards optimality while reducing the probability optimality score of the rebalance test most effectively.

Details on resampled efficient frontier and generation of a Michaud resampled efficient frontier are provided in U.S. Pat. No. 6,003,018, U.S. Pat. No. 7,624,060, and U.S. Pat. No. 7,412,414, the entire contents of each document are expressly incorporated herein by reference in their entirety. Any of the techniques (alone or in combination) taught in any of the above-referenced patent documents may be used in exemplary embodiments.

Details on the determination or selection of a target optimal portfolio on a Michaud resampled efficient frontier are provided in U.S. Pat. No. 6,003,018 and U.S. Pat. No. 7,412,414, the entire contents of each document are expressly incorporated herein by reference in their entirety. Any of the techniques (alone or in combination) taught in any of the above-referenced patent documents may be used in exemplary embodiments.

Details on the rebalance test, generation of a rebalance probability, and on determining an optimality discrepancy (e.g., tracking error) are provided in U.S. Patent Application Publication No. 2012/0116994, published May 10, 2012, titled “Dynamic Portfolio Monitoring,” U.S. Pat. No. 6,928,418, and in “Portfolio Monitoring In Theory And Practice,” JOIM, 2012, the entire contents of each document are expressly incorporated herein by reference in their entirety. Any of the techniques (alone or in combination) taught in any of the above-referenced patent documents may be used in exemplary embodiments.

### I. DEFINITIONS

Certain terms are defined in this section to facilitate understanding of exemplary embodiments.

“Portfolio,” as used herein, refers to the vector of real number coefficients associated with a set of “assets” or “factors” where the respective weights of the component assets define a point in a space referred to as “portfolio space” and where the range of coefficients are typically subject to equality and inequality constraints. An “asset” may be any state variable of a system.

“Michaud resampled efficient frontier” or “resampled efficient frontier,” as used herein, refer to a generalization of Markowitz (1952, 1959) mean-variance constrained portfolio optimization when the input return distribution is not known with certainty. Monte Carlo resampling methods are used to simulate many alternative statistically equivalent risk-return estimates and consequently many alternative statistically equivalently optimal Markowitz efficient frontiers. The Michaud resampled efficient frontier is defined based on an averaging process of properly associated simulated optimal portfolios for the portfolios on the simulated Markowitz efficient frontiers. The return-rank algorithm is a preferred embodiment of the averaging process that associates return ranks from one to N for each simulated Markowitz portfolio and averages the portfolios for each return rank to define the Michaud resampled efficient frontier optimal portfolios. Other averaging methods are also considered as compute efficient methods for defining the Michaud frontier. Generalizations of Markowitz, including addition of transaction costs or non-normal return distributions may also be incorporated.

“Optimal,” as used herein, refers to optimality in the Michaud resampled-efficient sense. An optimal portfolio—in the Michaud resampled-efficient sense—is one that maximizes a tradeoff of risk for return where there may be uncertainty in the precise estimate of risk and return of each asset in the portfolio.

“Optimal portfolio,” as used herein, refers to a portfolio selected in accordance with specified constraints of any nature so as to maximize expected utility or any other specified criteria subject to constraints such that the maximization is analytically intractable. Quadratic programming with linear inequalities and equalities and is a common example of an optimization procedure, and a typical optimal portfolio is a portfolio on the Michaud resampled efficient frontier computed as the average of properly associated simulated mean-variance efficient portfolios. However any procedure for determining an optimal portfolio is within the scope of the present invention. An optimal portfolio considered in a particular circumstance may be referred to herein as a “target portfolio” for that circumstance.

“Distance metric,” as used herein, refers to a real-valued function D(P1,P2) with portfolios P1 and P2 as arguments, which satisfies the following four properties:
1. D(P1,P2)>0 for all portfolios P1 and P2,
2. D(P1,P2)=0 if and only if P1=P2,
3. D(P1,P2)=D(P2,P1) for all portfolios P1 and P2, and
4. Satisfies the triangle inequality, i.e., D(P1,P3)<D(P1,P2)+D(P2,P3) for all P1, P2, and P3.

“Optimality discrepancy,” as used herein, refers to a distance metric of a portfolio against a target optimal portfolio. An example of optimality discrepancy may be, but is not limited to, the tracking error from a target optimal portfolio. In one embodiment, the tracking error is the standard deviation of portfolio distance (in portfolio space) of a given portfolio from a target optimal portfolio.

“Statistically optimal,” as used herein, means statistically equivalent to optimal, i.e., the optimality discrepancy of the portfolio in question is less than or equal to a designated percentile (L) of the optimality discrepancy evaluated on statistically equivalent portfolios to the optimal.

“Statistical equivalence,” as used herein, is determined by a set of statistical models for the inputs to the optimization procedure. Statistical equivalence for portfolios means that the total probability measure under these statistical models of the set of inputs which create portfolios with optimality discrepancies less than or equal to that of the portfolio in question is less than a designated threshold (L). Further details are provided in the following sections as well as in U.S. Pat. No. 6,003,018, U.S. Pat. No. 7,624,060, U.S. Pat. No. 7,412,414, U.S. Patent Application Publication No. 2012/0116994, published May 10, 2012, titled “Dynamic Portfolio Monitoring,” U.S. Pat. No. 6,928,418, and “Portfolio Monitoring In Theory And Practice,” JOIM, 2012, the entire contents of each of the documents are expressly incorporated herein by reference in their entirety. For example, U.S. Pat. No. 6,003,018 discloses a method for determining statistical equivalence. The concept of statistical equivalence may be affected by meta-resampling (as disclosed in U.S. Pat. No. 7,624,060), forecast confidence (as disclosed in U.S. Pat. No. 7,412,414), and subsample information periods (U.S. Patent Application Publication No. 2012/0116994). Any of the techniques (alone or in combination) taught in any of the above-referenced patent documents may be used in exemplary embodiments.

“Rebalance probability,” as used herein, is related to a Michaud resampled efficient frontier. Each portfolio on the Michaud frontier may be associated to simulated optimal portfolios via a Monte Carlo resampling process. A distance function such as the tracking error or relative variance can be used to define a distribution of distances of the simulated associated optimal portfolios in sorted from close to far relative to any portfolio on the Michaud frontier. The distance of a given investment portfolio can then be computed relative to a target Michaud optimal portfolio and compared to the distribution of distances computed from the simulated associated optimal portfolios. For example, if 10% of the simulated distances are closer than the distance associated with the given portfolio than it may be determined that the rebalance probability or need to trade probability is 10%. If 75% are closer, the rebalance probability may be defined as 75%. In this manner, a rebalance probability can be associated with any target portfolio on the Michaud resampled efficient frontier with respect to a given investment portfolio. In one embodiment, the rebalance probability is the probability that (P*, Pₜ) for a random draw is less than (P, Pₜ) for any specified portfolio. In particular, the term “observed rebalance probability,” as used herein, refers to the rebalance probability of an actual, or current, portfolio relative to a target portfolio.

“Trade,” as used herein, refers to a change in weights defining an existing portfolio.

“Trade cost,” as used herein, refers to a distance metric of a target portfolio from a currently held portfolio. Examples of trade cost functions include, but are not limited to, turnover or expected trading cost. In one embodiment, turnover may be determined as the amount of portfolio weight either bought or sold in a trade. In one embodiment, expected trading cost may be determined based on a trading cost model. The trade cost function need not be the same type of distance metric as used for the optimality discrepancy function, described below.

“Computer-readable medium,” as used herein, refers to a non-transitory storage hardware, non-transitory storage device or non-transitory computer system memory that may be accessed by a controller, a microcontroller, a computational system or a module of a computational system to encode thereon computer-executable instructions or software programs. The “computer-readable medium” may be accessed by a computational system or a module of a computational system to retrieve and/or execute the computer-executable instructions or software programs encoded on the medium. The non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM) and the like.

“Equal,” as used herein, refers, in a broad lay sense, to exact equality or approximate equality within some tolerance.

### II. EXEMPLARY NON-LIMITING EMBODIMENTS

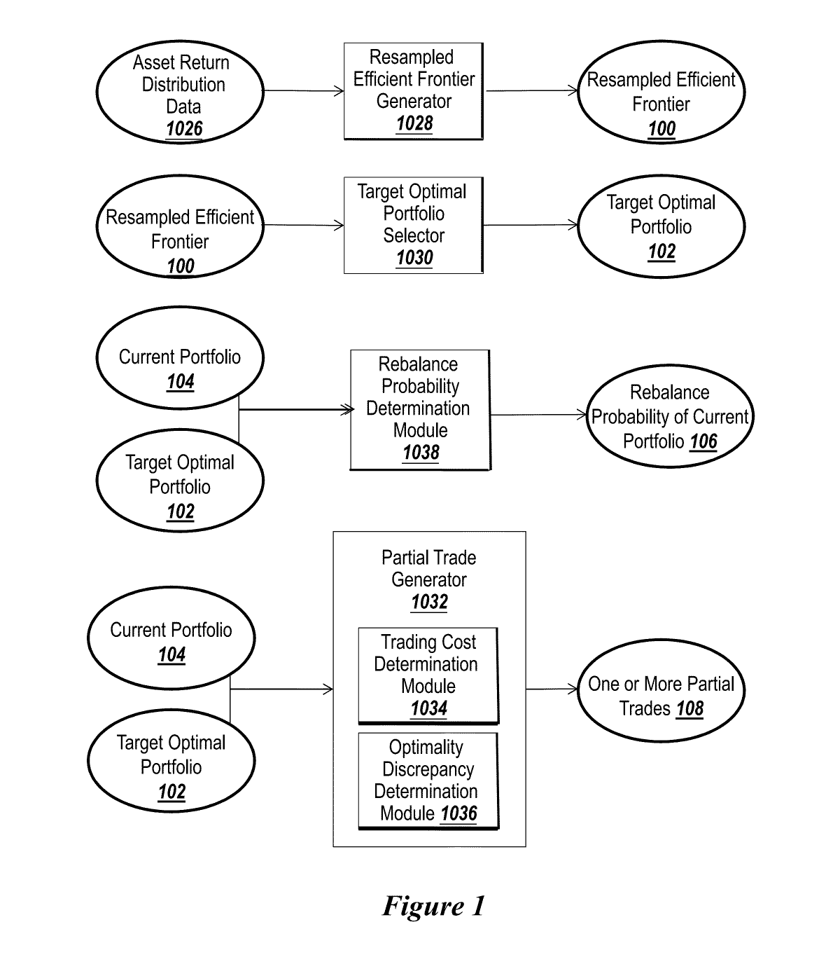

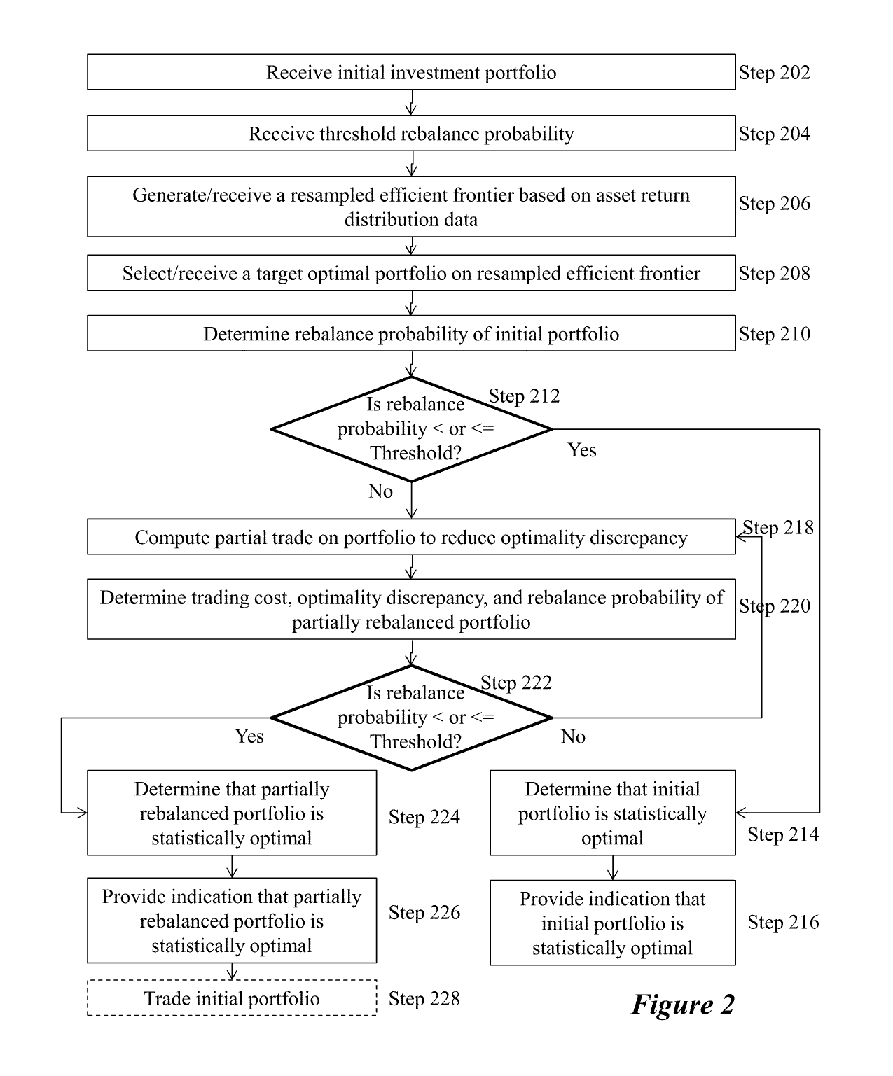

Certain exemplary non-limiting methods, systems and devices are described with reference to FIGS. 1 and 2.

FIG. 1 is a block diagram of certain exemplary computer-implemented and computer-executable modules of an exemplary computer modeling system. Instructions to programmatically execute the computer-implemented and computer-executable modules may be encoded on one or more computer-readable media. One of ordinary skill in the art will recognize that the exemplary modules of FIG. 1 are illustrative and may be configured to accept more or fewer inputs and to generate more or fewer results. More or fewer modules may also be used within the scope of the invention.

A resampled efficient frontier generator 1028 receives, as input, asset return distribution data 1026 containing mean, variance and correlation data on a plurality of asset classes. The resampled efficient frontier generator 1028 generates a Michaud resampled efficient frontier 100 based on input data 1026.

A target optimal portfolio selector 1030 receives, as input, a Michaud resampled efficient frontier 100 (and, optionally, one or more criteria on investment preferences). The target optimal portfolio selector 1030 selects or determines one or more target optimal portfolios 102 on the Michaud resampled efficient frontier 100.

A rebalance probability determination module 1038 receives, as input, a current portfolio 104 (which may be an initial portfolio or a partially rebalanced portfolio) and a target optimal portfolio 102. The rebalance probability determination module 1038 generates a rebalance probability 106 associated with the portfolio 104. The rebalance probability is a score based on comparing the distances of simulated typical portfolios for a given optimal portfolio on the Michaud resampled efficient frontier against the tracking error of the current portfolio. In some embodiments, if the target optimal portfolio 102 is not the result of the Michaud resampled efficient frontier 100, then another optimal portfolio chosen from a resampled efficient frontier can be used instead by the rebalance probability determination module 1038.

A partial trade generator 1032 receives, as input, the current portfolio 104 and the target optimal portfolio 102, and models a trading path that reduces the optimality discrepancy of the portfolio relative to the target optimal portfolio. The trading path may include of one or more modeled partial trades 108. A trade cost determination module 1034 may be used for determining a trade cost associated with a modeled partial trade on a portfolio. An optimality discrepancy determination module 1036 may be used for determining the turnover or tracking error associated with a portfolio relative to a target optimal portfolio. In some embodiments, the partial trade generator 1032 may include the trading cost determination module 1034 and the optimality discrepancy determination module 1036. In other embodiments, the trading cost determination module 1034 and the optimality discrepancy determination module 1036 may be provided separately from the partial trade generator 1032 in a way to allow access by the partial trade generator 1032.

FIG. 2 is a flowchart of an exemplary method for modeling one or more partial trades to rebalance an initial investment portfolio relative. In step 202, data/information on an initial investment portfolio is received. In step 204, a threshold rebalance probability is received. The threshold value is a rebalance probability below which (or equal to or below which) a portfolio is deemed statistically optimal relative to the target optimal portfolio. Any suitable threshold value may be used in exemplary methods including, but not limited to, about 5% to about 80%. An exemplary threshold value may be, for example, about 50%. The threshold rebalance probability may remain fixed during the method of FIG. 2 or may be reset or changed during the method of FIG. 2.

### (a) Generation of Michaud Resampled Efficient Frontier

In step 206, a Michaud resampled efficient frontier is received or generated based on asset return distribution data. The asset return distribution data may include mean, variance (and/or standard deviation) and correlation data on a plurality of asset classes.

### (b) Selection of Target Optimal Portfolio

In step 208, a target optimal portfolio on the Michaud resampled efficient frontier is received or selected. The target optimal portfolio may be selected based on one or more criteria (e.g., investment preferences of an investor). If the target optimal portfolio is not the result of Michaud resampled efficient frontier, then a another optimal portfolio chosen from a resampled efficient frontier can be used in its place to generate a rebalance probability.

### (c) Assessment of Statistical Optimality of Initial Portfolio

In step 210, the rebalance probability of the initial portfolio is determined. The rebalance probability is a score based on comparing the distances of simulated typical portfolios for a given optimal portfolio on the Michaud resampled efficient frontier against the tracking error of the current portfolio. The score itself is a one-to-one monotone increasing function of the tracking error from optimal, ranging from 0 to 1. A simple mean-variance active weight optimization with mean equal to negative turnover from current portfolio (dummy variables may need to be set up to measure this turnover), and variance equal to the tracking error from the benchmark, equal to the target optimal, will find the minimum turnover, minimum tracking error frontier which spans the current portfolio to the target optimal. If the rebalance test used tracking error for its distance measure, this frontier would represent the trading path most effective for reducing the rebalance statistic, at minimum turnover for a given tracking error reduction. The procedure has the desirable property, in this setting, of isolating trades to the most effective direction, until a constraint boundary is hit. Rather than trading every asset simultaneously, it will trade assets one or several at a time, executing the most efficacious trades first.

In step 212, the rebalance probability of the first portfolio is compared to the threshold rebalance probability.

In step 214, if the rebalance probability of the initial portfolio is lower than (or lower than or equal to) the threshold, it is deemed that the initial portfolio is statistically optimal relative to the target optimal portfolio.

In step 216, an indication may be provided that that initial portfolio is deemed statistically optimal relative to the target optimal portfolio and, optionally, that the procedure for finding less-distant portfolios (relative to the target optimal portfolio) can be stopped, i.e., that further rebalancing is not required. The indication may be presented on a user interface displayed on a visual display device in some embodiments, for example, as a message to an investment manager.

However, if in step 212, if the rebalance probability of the initial portfolio is not lower than (or lower than or equal to) the threshold, it is deemed that the first portfolio is not statistically optimal relative to the target optimal portfolio. In this case, one or more partial trades are required to move to a portfolio that will be statistically optimal relative to the target optimal portfolio. The method thus proceeds to step 218 to model one or more partial trades until a statistically optimal portfolio is detected.

(d) Generation of Trading Path from Initial Portfolio Toward Target Optimal Portfolio

Exemplary embodiments generate a trading path starting at the initial portfolio and including a series of one or more modeled partial trades moving closer to the target optimal portfolio. In some embodiments, the initial portfolio may be rebalanced completely to the target optimal portfolio which, in other embodiments, the initial portfolio may be rebalanced completely to the target optimal portfolio. A series of one or more modeled partial trades constitute the trading path that reduces the optimality discrepancy of the portfolio relative to the target optimal portfolio. In generating the trading path, in step 218, a first partial trade is computed or modeled on the initial portfolio toward the target optimal portfolio to reduce the optimality discrepancy to generate a first partially rebalanced portfolio. The first partial trade does not rebalance completely to the target optimal portfolio in some embodiments, such that the first partially rebalanced portfolio is different from the target optimal portfolio.

In some embodiments, the trading path determined (i.e., the path associated with the partial trade at step 218) is the most efficient trading path that maximizes reduction in the optimality discrepancy per unit of turnover or trading cost. This efficient trading path maximizes the impact or benefit of rebalancing per unit of trading cost. An exemplary non-limiting optimization process, for determining the most efficient trading path from the initial portfolio to the target optimal portfolio, will now be described. Dummy variables are set up for turnover. This means, for asset A: adding two variables (“Asset A buy” and “Asset A sell”) to the optimization, constraining each of these to be non-negative, and adding an equality constraint that the buy minus the sell dummy variable must equal the asset weight minus the current asset weight. These constraints ensure that the dummy variables reflect turnover and do not add any degrees of freedom to the solution. A series quadratic programming optimization process is then performed, which linearly constrains the total turnover (equal to the sum of all the dummy variables) to a specific intermediate value, and minimizes the quadratic form which is the square of the tracking error from optimal. That is, if a portfolio being optimized is P, and Pₒₚₜ is the target optimal, exemplary embodiments minimize the quadratic form (P−Pₒₚₜ)′*Sigma*(P−P_{wt}), i.e., the variance of the portfolio difference, subject to the constraint. This process determines the efficient trading path from the initial portfolio to the target optimal portfolio. The entire frontier can also be found by the critical line process with just one quadratic programming optimization and by recursively recalculating efficient trade directions at each traversal of a constraint boundary.

In this optimization process, it may often be desirable to add constraints to the system, or to modify the existing constraint set. For example, it may make sense to constrain portfolio weights on either side of the trade so as not to overshoot or go against the direction of the trades. On the other hand, it may be advantageous not to add constraints to an already constrained case: a portfolio closer to optimal may be available outside the interval between current and optimal, and the fastest way to optimal may overshoot the target, or undershoot the current portfolio. It may also be desirable to constrain assets to their weights in the initial portfolio if those assets cannot be traded, for whatever reason. One of ordinary skill in the art would know how to minimize the tracking error of a portfolio relative to a target portfolio.

Other considerations include whether the initial portfolio is outside the constraint set for the current case. In this instance, it may be desirable to relax the current constraint set to include the current asset weight, so that the initial portfolio does not violate the constraint set and so that the procedure will produce a smooth path from the current portfolio to the optimal one. This is the case for a contributed portfolio containing assets outside the optimization universe. If the mean and variance estimates are available for the augmented universe containing the contributed assets, the process can show the most effective stepwise trades into the new optimal portfolio.

The optimization process to find the set of optimal trades along the trading path from the current portfolio to the target optimal portfolio can be based on one or more criteria, so long as the trade cost function is minimized at the initial portfolio and the optimality discrepancy function is minimized at the target optimal portfolio. The optimality discrepancy function need not be solely a function of tracking error, but could, for example, include a measure of the difference in expected return as well. The optimality discrepancy function could also use a different measure of risk than variance, for example, value at risk (relative to the optimal portfolio). The trade cost function is similarly flexible, but may represent taxes, transaction costs, or turnover when that approximates the costs associated with the problem. The optimality discrepancy function needs to be identical or relatable to the function used in calculating the rebalance score. The optimization process itself can be chosen from any of the methods known to be able to solve the trade cost and optimality discrepancy optimization problem.

In certain other embodiments, the trading path determined (i.e., the path associated with the partial trade at step 218) may not be the most efficient trading path but will reduce the optimality discrepancy relative to the target optimal portfolio and have the desirable character of simplicity of computation. One exemplary technique of determining a trading path is to halve the optimality discrepancy of each asset in the investment portfolio relative to the target weight at each step of the trading procedure. Such a technique has the property of approaching the target portfolio as a limit and for enabling definition of a partial trade portfolio for a given threshold probability level. Another exemplary technique involves computation of a series of random trades in random assets that reduce the optimality discrepancy relative to the target optimal portfolio for enabling definition of a partial trade portfolio for a given threshold probability level.

### (e) Assessment of Statistical Optimality of Partially or Fully Rebalanced Portfolio

In step 220, upon generating the partially rebalanced portfolio, the following values are determined: the trade cost (or turnover) associated with the partial trade, the tracking error of the partially rebalanced portfolio relative to the target optimal portfolio, and the rebalance probability of the partially rebalanced portfolio.

In step 222, the rebalance probability of the partially rebalanced portfolio is compared to the threshold.

In step 224, if the rebalance probability of the partially rebalanced portfolio is lower than (or lower than or equal to) the threshold, it is deemed that the partially rebalanced portfolio is statistically optimal relative to the target optimal portfolio.

In step 226, an indication may be provided that that partially rebalanced portfolio is deemed statistically optimal relative to the target optimal portfolio and, optionally, that further rebalancing is not required. The indication may be presented on a user interface displayed on a visual display device in some embodiments, for example, as a message to an investment manager.

In certain embodiments, in step 228, one or more partial trades may be conducted on the initial portfolio in accordance with the partial trades modeled in step 218 in order to arrive at a statistically optimal portfolio.

However, in step 222, if the rebalance probability of the partially rebalanced portfolio is not lower than (or lower than or equal to) the threshold, it is deemed that the partially rebalanced portfolio is not statistically optimal relative to the target optimal portfolio. In this case, further partial trades are required to move to a portfolio that will be statistically optimal. The method thus returns to step 218 and repeats steps 218-222 to model one or more further partial trades until a statistically optimal portfolio is detected.

In certain embodiments in which an efficient trading path is determined (to reduce trading cost), the first detected statistically optimal portfolio may be the statistically optimal portfolio with minimum trade cost (or turnover). The statistically optimal portfolio with the minimum trade cost (or turnover) may be presented on a user interface displayed on a visual display device in some embodiments, for example, as a message to an investment manager.

(f) Determination of Statistically Optimal Portfolio with Globally Minimum Trade Cost or Turnover

In some embodiments, a statistically optimal portfolio with a globally minimum trade cost (or turnover) is determined and, optionally, presented on a user interface displayed on a visual display device in some embodiments, for example, as a message to an investment manager. A globally minimum trade cost (or turnover) is determined on the basis of a plurality of target optimal portfolios on the Michaud resampled efficient frontier. That is, the steps of the exemplary method of FIG. 2 are repeated for each of a plurality of target optimal portfolios selected from the Michaud resampled efficient frontier. Each iteration of the method (for a particular target optimal portfolio) yields a particular statically optimal portfolio with minimum trade cost, so that a plurality of such statistically optimal portfolios is generated, each having an associated minimum trade cost. The statistically optimal portfolio with the globally minimum trade cost may be selected to rebalance the initial portfolio.

### III. EXEMPLIFICATION

This section describes the use of the method of FIG. 2 in rebalancing two exemplary initial portfolios. One of ordinary skill in the art will recognize that these uses are exemplary and non-limiting and are described herein for illustrative purposes.

### (a) First Example

Exemplary embodiments were used to generate or receive mean, standard deviation (and/or variance) and correlation estimates for eight asset classes from a canonical dataset of asset returns. Table 1 summarizes the generated input mean-variance data.

TABLE 1
Mean-variance estimates for asset classes

| | | | Correlation | | | | | | | |
|---|---|---|---|---|---|---|---|---|---|---|
| Asset | | Standard | Euro | | | | | | | |
| Name | Return | Deviation | Bonds | US Bonds | Canada | France | Germany | Japan | UK | US |
| Euro | 3.2% | 5.4% | 1.0000 | 0.9207 | 0.3257 | 0.2612 | 0.2812 | 0.1636 | 0.2868 | 0.4239 |
| Bonds | | | | | | | | | | |
| US Bonds | 3.0% | 7.0% | 0.9207 | 1.0000 | 0.2585 | 0.2211 | 0.2660 | 0.1444 | 0.2471 | 0.3601 |
| Canada | 4.6% | 19.0% | 0.3257 | 0.2585 | 1.0000 | 0.4112 | 0.2980 | 0.2484 | 0.5794 | 0.7112 |
| France | 10.5% | 24.4% | 0.2612 | 0.2211 | 0.4112 | 1.0000 | 0.6233 | 0.4212 | 0.5360 | 0.4441 |
| Germany | 6.4% | 21.5% | 0.2812 | 0.2660 | 0.2980 | 0.6233 | 1.0000 | 0.3508 | 0.4808 | 0.3434 |
| Japan | 10.5% | 24.4% | 0.1636 | 0.1444 | 0.2484 | 0.4212 | 0.3508 | 1.0000 | 0.3996 | 0.2217 |
| UK | 9.5% | 20.8% | 0.2868 | 0.2471 | 0.5794 | 0.5360 | 0.4808 | 0.3996 | 1.0000 | 0.5629 |
| US | 8.5% | 14.9% | 0.4239 | 0.3601 | 0.7112 | 0.4441 | 0.3434 | 0.2217 | 0.5629 | 1.0000 |

Data on a current or initial investment portfolio was provided. The second column of Table 2 summarizes the asset weights of the current portfolio. As summarized in Table 2, the turnover (or trade cost) of the exemplary initial portfolio is 0%, the tracking error (relative to the target optimal portfolio) is about 1.77%, and the rebalance probability is about 68.1%.

Exemplary embodiments were used to generate or receive a target optimal portfolio. The third column of Table 3 summarizes the asset weights of the target optimal portfolio. As summarized in Table 2, the turnover (or trade cost) of the exemplary target optimal portfolio is about 30.48%, the tracking error (relative to the target optimal portfolio) is 0%, and the rebalance probability is 0%.

Together, Tables 1 and 2 define all necessary inputs to execute the exemplary partial rebalancing method while minimizing trade cost (or turnover).

TABLE 2
Asset weights for current portfolio and target optimal portfolio

| | Current | Target Optimal | Trade |
|---|---|---|---|
| Asset Name | Portfolio | Portfolio | Amounts |
| Euro Bonds | 5.0% | 28.64% | 23.64% |
| US Bonds | 25.0% | 11.60% | −13.40% |
| Canada | 5.0% | 2.57% | −2.43% |
| France | 5.0% | 8.25% | 3.25% |
| Germany | 5.0% | 4.92% | −0.08% |
| Japan | 15.0% | 13.40% | −1.60% |
| UK | 5.0% | 8.59% | 3.59% |
| US | 35.0% | 22.03% | −12.97% |
| Turnover | 0.0% | 30.48% | |
| Tracking Error | 1.77% | 0% | |
| Rebalance Probability | 68.1% | 0% | |

In an exemplary embodiment, a target optimal portfolio lies on a Michaud resampled efficient frontier. In this embodiment, a Michaud resampled efficient frontier may be received or generated based on the input mean-variance data. The target optimal portfolio may be selected on the Michaud resampled efficient frontier based on one or more criteria (e.g., investment preferences of an investor). In the example illustrated, the Michaud resampled efficient frontier was generated with a forecast confidence of 4, t distribution returns, and arc length rank association. The target optimal portfolio was selected to be close to a 60/40 stock-bond ratio.

Given the data in Tables 1 and 2, exemplary embodiments were used to model a series of partial trades toward the target optimal portfolio, but that do not completely reach the target optimal portfolio. The series of partial trades form or constitute a trading path that reduces the optimality discrepancy relative to the target optimal portfolio. Upon modeling each partial trade, the trade cost, tracking error and rebalance probability of the partially rebalanced portfolio were determined. The rebalance test was run with k=3.

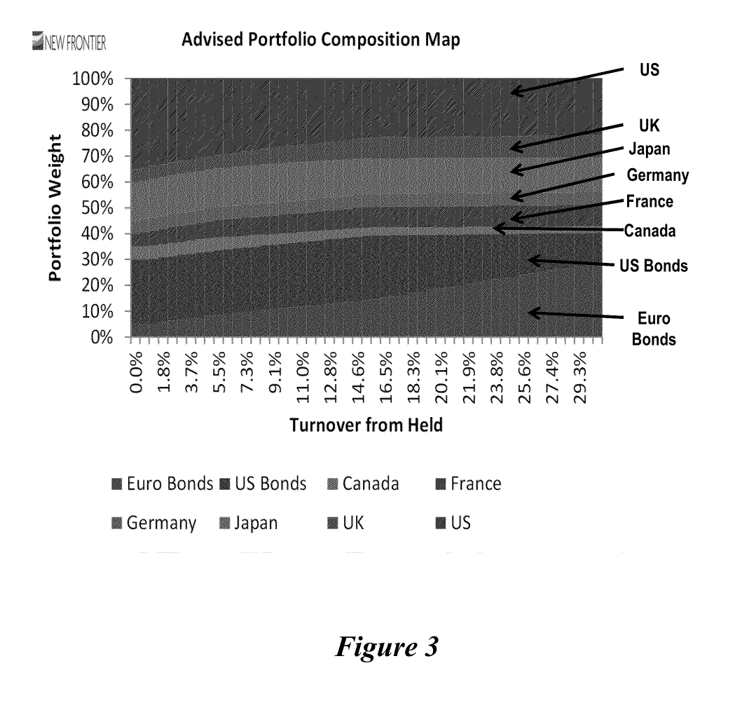

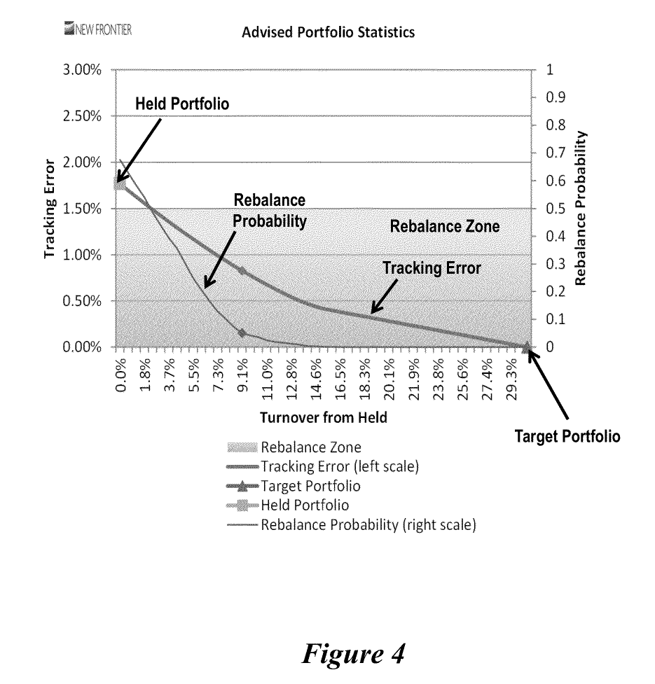

Table 3 summarizes some exemplary partial trades in the trading path. FIG. 3 illustrates a portfolio composition map that shows the effects of the partial trades on portfolio weights and associated turnover (or trade cost). FIG. 4 illustrates a portfolio statistics graph associated with the trading path, showing how the tracking error and the rebalance probability are minimized along the trading path. The trades are effectively broken out, and the first trades reduce the tracking error and rebalance probability most effectively per unit of trade cost or turnover.

Exemplary embodiments receive a threshold level of rebalance probability below which (or equal to or below which) a rebalanced portfolio is deemed statistically optimal relative to the target optimal portfolio. In this example, the threshold rebalance probability is 50%. The shaded region in FIG. 4 (below a horizontal level of 0.5 rebalance probability) illustrates the range of rebalanced portfolios that fall within this statistically optimal range.

If a rebalanced portfolio lies within the shaded region of FIG. 4 (i.e., has a rebalance probability below the threshold of 50%), exemplary embodiments may determine that the portfolio is deemed statistically optimal and that further rebalancing is not needed.

Exemplary embodiments may be used to determine the first rebalanced portfolio along the trading path that reaches statistical optimality (i.e., has a rebalance probability below the threshold of 50%). As shown in Table 3, partial trade #3.59 (interpolated between trades 3 and 4) is the first rebalanced portfolio to have a rebalance score of 50%.

TABLE 3
Partial trades toward target optimal portfolio constituting trading path

| | Rank of Partial Trade: | | | | | | | | | |
|---|---|---|---|---|---|---|---|---|---|---|
| | | | First statistically optimal | | | | | | | |
| | | | portfolio reached | | | | | | | |
| | 1 of 50 | | 3.59 of 50 | | 7 of 50 | | 10 of 50 | | 16 of 50 | |
| | Trade to | Trades | Trade to | Trades | Trade to | Trades | Trade to | Trades | Trade to | Trades |
| Euro Bonds | 5.0% | — | 6.1% | 1.1% | 7.7% | 2.7% | 8.7% | 3.7% | 10.8% | 5.8% |
| US Bonds | 25.0% | — | 25.0% | — | 25.0% | — | 25.0% | — | 25.0% | — |
| Canada | 5.0% | — | 5.0% | — | 5.0% | — | 4.8% | −0.2% | 4.0% | −1.0% |
| France | 5.6% | 0.6% | 6.1% | 1.1% | 6.6% | 1.6% | 6.8% | 1.8% | 7.2% | 2.2% |
| Germany | 5.0% | — | 5.0% | — | 5.0% | — | 5.0% | — | 5.0% | — |
| Japan | 15.0% | — | 15.0% | — | 15.0% | — | 15.0% | — | 15.0% | — |
| UK | 5.0% | — | 5.0% | — | 5.0% | — | 5.0% | — | 6.2% | 1.2% |
| US | 34.4% | −0.6% | 32.8% | −2.2% | 30.7% | −4.3% | 29.7% | −5.3% | 26.8% | −8.2% |
| Turnover: | | 0.6% | | 2.2% | | 4.3% | | 5.5% | | 9.1% |
| Tracking Error: | | 1.7% | | 1.5% | | 1.3% | | 1.2% | | 0.8% |
| Rebalance Probability: | | 63.4% | | 50.0% | | 35.7% | | 24.8% | | 5.1% |

### (b) Second Example

The second example illustrates partial rebalancing of an initial portfolio that is far from optimal and that has a rebalance probability of 100%. This example shows that a higher level of trading must occur (compared to the first example) before the rebalance probability decreases at all from 100%.

The mean, standard deviation (and/or variance) and correlation estimates shown in Table 1 were used.

Data on a current or initial investment portfolio was provided. The second column of Table 4 summarizes the asset weights of the current portfolio. The initial portfolio exclusively included US bonds.

Exemplary embodiments were used to generate or receive a target optimal portfolio. The third column of Table 4 summarizes the asset weights of the target optimal portfolio.

TABLE 4
Asset weights for current portfolio and target optimal portfolio

| | Current | Target Optimal | Trade |
|---|---|---|---|
| Asset Name | Portfolio | Portfolio | Amounts |
| Euro Bonds | 0.0% | 39.43% | 39.43% |
| US Bonds | 100.0% | 0.00% | −100.00% |
| Canada | 0.0% | 2.55% | 2.55% |
| France | 0.0% | 8.16% | 8.16% |
| Germany | 0.0% | 5.10% | 5.10% |
| Japan | 0.0% | 13.58% | 13.58% |
| UK | 0.0% | 8.60% | 8.60% |
| US | 0.0% | 22.58% | 22.58% |
| Turnover | 0.0% | 30.48% | |
| Tracking Error | 4.3% | 0% | |
| Rebalance | 100.0% | 0% | |
| Probability | | | |

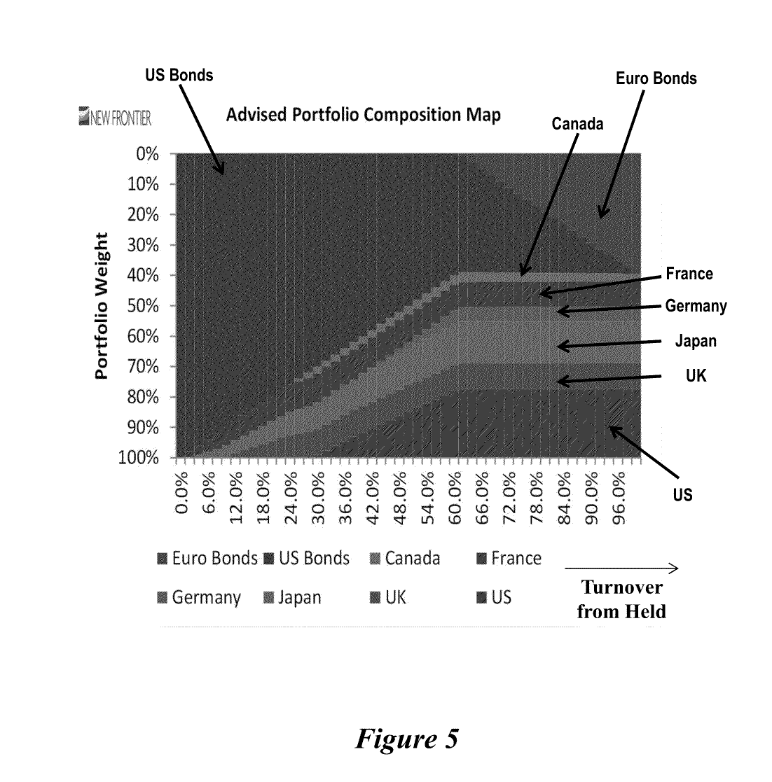

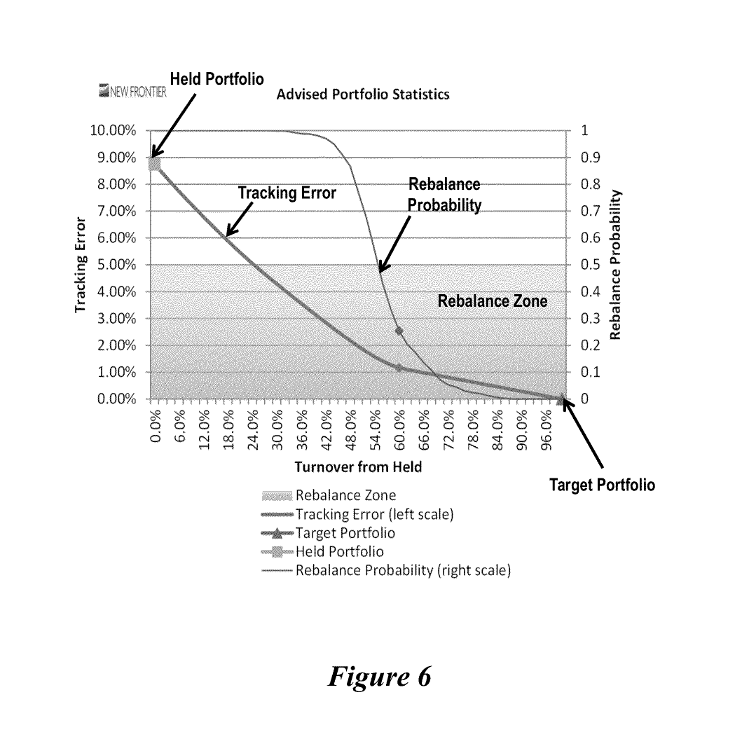

Table 5 summarizes some exemplary partial trades in the trading path. FIG. 5 illustrates a portfolio composition map that shows the effects of the partial trades on portfolio weights and associated turnover (or trade cost). FIG. 6 illustrates a portfolio statistics graph associated with the trading path, showing how the tracking error and the rebalance probability are minimized along the trading path. The trades are effectively broken out, and several trades are initially required to reduce the rebalance probability. US Bonds starts at 100%, and 2% is traded away at each step of the trade path. The last asset to be traded into is Euro Bonds, which provides the least reduction in tracking error per unit of turnover (or trade cost).

Exemplary embodiments receive a threshold level of rebalance probability below which (or equal to or below which) a rebalanced portfolio is deemed statistically optimal relative to the target optimal portfolio. In this example, the threshold rebalance probability is 50%. The shaded region in FIG. 6 (below a horizontal level of 0.5 rebalance probability) illustrates the range of rebalanced portfolios that fall within this statistically optimal range.

If a rebalanced portfolio lies within the shaded region of FIG. 6 (i.e., has a rebalance probability below the threshold of 50%), exemplary embodiments may determine that the portfolio is deemed statistically optimal and that further rebalancing is not needed.

Exemplary embodiments may be used to determine the first rebalanced portfolio along the trading path that reaches statistical optimality (i.e., has a rebalance probability below the threshold of 50%). As shown in Table 5, partial trade #27.52 (interpolated between trades 27 and 28) is the first rebalanced portfolio to have a rebalance score of 50%.

TABLE 5
Partial trades toward target optimal portfolio constituting trading path

| | Rank of Partial Trade: | | | | | | | | | |
|---|---|---|---|---|---|---|---|---|---|---|
| | | | | | | | First statistically optimal | | | |
| | | | | | | | portfolio reached | | | |
| | 1 of 50 | | 4 of 50 | | 11 of 50 | | 27.52 of 50 | | 30 of 50 | |
| | Trade to | Trades | Trade to | Trades | Trade to | Trades | Trade to | Trades | Trade to | Trades |
| Euro Bonds | — | — | — | — | — | — | — | — | — | — |
| US Bonds | 98.00% | −2.00% | 92.00% | −8.00% | 78.00% | −22.00% | 45.0% | −55.0% | 40.00% | −60.00% |
| Canada | — | — | — | — | — | — | 3.0% | 3.0% | 3.11% | 3.11% |
| France | 2.00% | 2.00% | 5.13% | 5.13% | 8.46% | 8.46% | 8.8% | 8.8% | 8.44% | 8.44% |
| Germany | — | — | — | — | — | — | 3.3% | 3.3% | 4.45% | 4.45% |
| Japan | 0.00% | 0.00% | 2.87% | 2.87% | 6.98% | 6.98% | 12.8% | 12.8% | 13.57% | 13.57% |
| UK | — | — | — | — | 6.56% | 6.56% | 8.5% | 8.5% | 8.52% | 8.52% |
| US | — | — | — | — | — | — | 18.7% | 18.7% | 21.91% | 21.91% |
| Turnover: | | 2.0% | | 8.0% | | 22.0% | | 55.0% | | 60.0% |
| Tracking Error: | | 8.4% | | 7.4% | | 5.3% | | 1.5% | | 1.2% |
| Rebalance Probability: | | 100.0% | | 100.0% | | 100.0% | | 50.0% | | 25.4% |

### IV. EXEMPLARY COMPUTING DEVICE AND NETWORK ENVIRONMENT

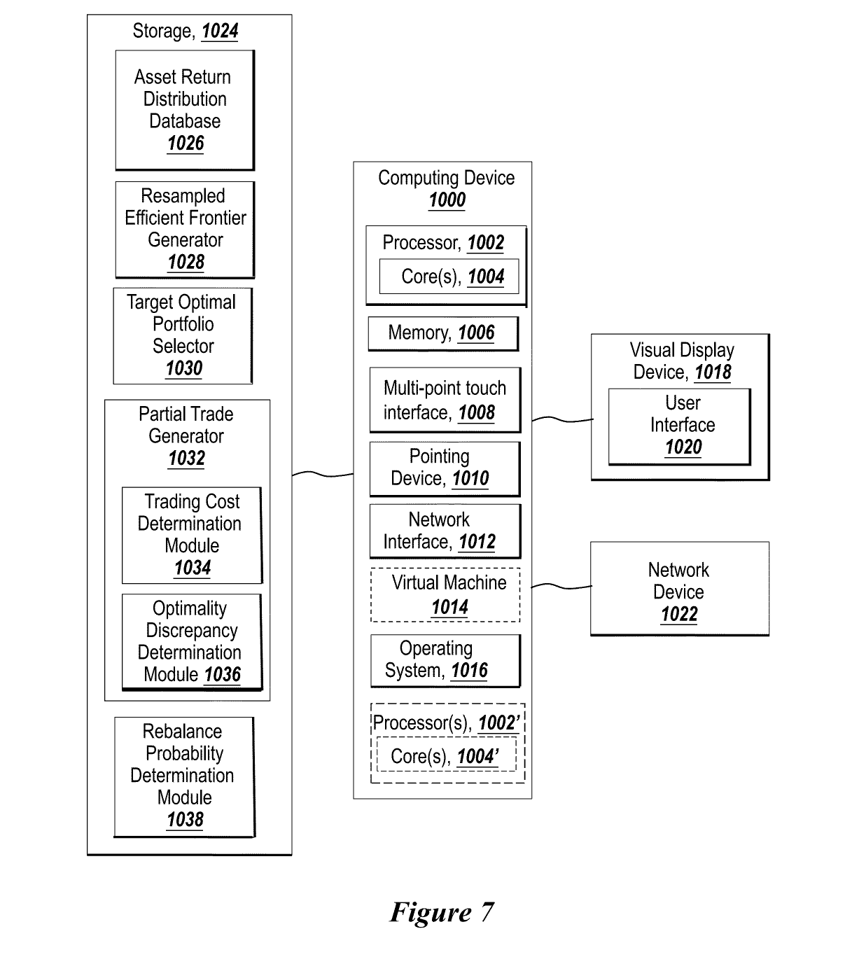

FIG. 7 is a block diagram of an exemplary computing device 1000 that may be used in to perform any of the methods provided by exemplary embodiments. The computing device 1000 may be any suitable computing or communication device or system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 1000 includes one or more non-transitory computer-readable media for storing one or more computer-executable instructions, programs or software for implementing exemplary embodiments. The non-transitory computer-readable media may include, but are not limited to, one or more types of hardware memory, non-transitory tangible media (for example, one or more magnetic storage disks, one or more optical disks, one or more USB flashdrives), and the like. For example, memory 1006 included in the computing device 1000 may store computer-readable and computer-executable instructions, programs or software for implementing exemplary embodiments. Memory 1006 may include a computer system memory or random access memory, such as DRAM, SRAM, EDO RAM, and the like. Memory 1006 may include other types of memory as well, or combinations thereof.

The computing device 1000 also includes processor 1002 and associated core 1004, and optionally, one or more additional processor(s) 1002′ and associated core(s) 1004′ (for example, in the case of computer systems having multiple processors/cores), for executing computer-readable and computer-executable instructions or software stored in the memory 1006 and other programs for controlling system hardware. Processor 1002 and processor(s) 1002′ may each be a single core processor or multiple core (1004 and 1004′) processor.

Virtualization may be employed in the computing device 1000 so that infrastructure and resources in the computing device may be shared dynamically. A virtual machine 1014 may be provided to handle a process running on multiple processors so that the process appears to be using only one computing resource rather than multiple computing resources. Multiple virtual machines may also be used with one processor.

A user may interact with the computing device 1000 through a visual display device 1018, such as a computer monitor, which may display one or more user interfaces 1020 that may be provided in accordance with exemplary embodiments, for example, a user interface for indicating to a user that a rebalanced portfolio is statistically optimal relative to a target optimal portfolio on a Michaud resampled efficient frontier, for displaying a Michaud resampled efficient frontier, for displaying an asset composition map of one or more portfolios, for displaying input data corresponding to asset returns, and the like. The visual display device 1018 may also display other aspects, elements and/or information or data associated with exemplary embodiments. The computing device 1000 may include other input/output (I/O) devices for receiving input from a user, for example, a keyboard or any suitable multi-point touch interface 1008, a pointing device 1010 (e.g., a mouse). The keyboard 1008 and the pointing device 1010 may be coupled to the visual display device 1018. The computing device 1000 may include other suitable conventional I/O peripherals.

The computing device 1000 may include one or more storage devices 1024, such as a hard-drive, CD-ROM, or other computer readable media, for storing data and computer-readable instructions and/or software that implement the methods taught herein. Exemplary storage device 1024 may also store one or more databases for storing any suitable information required to implement exemplary embodiments. The databases may be updated by a user or automatically at any suitable time to add, delete or update one or more items in the databases. For example, exemplary storage device 1024 may store one or more asset return distribution databases 1026 for storing mean, variance and correlation data corresponding to the returns of different asset classes (e.g., Euro bonds, US bonds, stocks). An exemplary data set selected from an asset return distribution database is represented in Table 1.

Exemplary storage device 1024 may store a resampled efficient frontier generator 1028 for using mean-variance input data to generate a Michaud resampled efficient frontier. Exemplary storage device 1024 may store a target optimal portfolio selector 1030 for selecting one or more target optimal portfolios on a Michaud resampled efficient frontier based on one or more criteria. Exemplary storage device 1024 may store a partial trade generator 1032 for modeling and/or performing one or more partial trades on a current portfolio toward a target optimal portfolio in order to reduce the optimality discrepancy. Exemplary storage device 1024 may store a trade cost determination module 1034 for determining a trade cost associated with a partial trade on a portfolio. Exemplary storage device 1024 may store an optimality discrepancy determination module 1036 for determining an optimality discrepancy of a portfolio relative to a target optimal portfolio. In some embodiments, the partial trade generator 1032 may include the trading cost determination module 1034 and the optimality discrepancy determination module 1036. In other embodiments, the trading cost determination module 1034 and the optimality discrepancy determination module 1036 may be provided separately from the partial trade generator 1032 in a way to allow access by the partial trade generator 1032. Exemplary storage device 1024 may store a rebalance probability determination module 1038 for determining a rebalance probability for a portfolio.

The computing device 1000 may include a network interface 1012 configured to interface via one or more network devices 1022 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 1012 may include a built-in network adapter, network interface card, PCMCIA network card, card bus network adapter, wireless network adapter, USB network adapter, modem or any other device suitable for interfacing the computing device 1000 to any type of network capable of communication and performing the operations described herein.

The computing device 1000 may run any operating system 1016, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 1016 may be run in native mode or emulated mode. In an exemplary embodiment, the operating system 1016 may be run on one or more cloud machine instances.

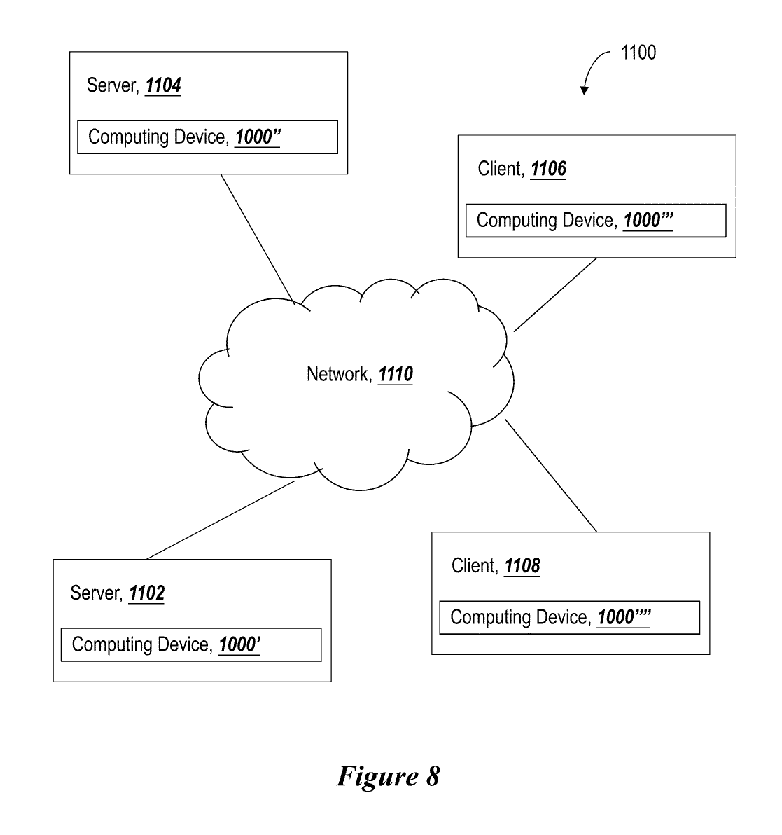

FIG. 8 is a block diagram of an exemplary network environment 1100 suitable for a distributed implementation of exemplary embodiments. The network environment 1100 may include one or more servers 1102 and 1104 coupled to one or more clients 1106 and 1108 via a communication network 1110. The servers 1102 and 1104 may take the form of or include one or more computing devices 1000′ and 1000″, respectively, that are similar to the computing device 1000 illustrated in FIG. 7. Similarly, the clients 1106 and 1108 may take the form of or include one or more computing devices 1000′ and 1000″′, respectively, that are similar to the computing device 1000 illustrated in FIG. 7.

The network interface 1012 and the network device 1022 of the computing device 1000 enable the servers 1102 and 1104 to communicate with the clients 1106 and 1108 via the communication network 1110. The communication network 1110 may include, but is not limited to, the Internet, an intranet, a LAN (Local Area Network), a WAN (Wide Area Network), a MAN (Metropolitan Area Network), a wireless network, an optical network, and the like. The communication facilities provided by the communication network 1110 are capable of supporting distributed implementations of exemplary embodiments.

In an exemplary embodiment, the servers 1102 and 1104 may provide the clients 1106 and 1108 with computer-readable and/or computer-executable components or products under a particular condition, such as a license agreement. The computer-readable and/or computer-executable components or products may include those for generating a Michaud resampled efficient frontier, determining a target optimal portfolio on the Michaud resampled efficient frontier, determining one or more partial trades from a current portfolio, determining turnover, tracking error and rebalance probabilities associated with the partially rebalanced portfolios, and determining that a partially rebalanced portfolio is statistically optimal. The clients 1106 and 1108 may have a current portfolio, and may use the components or products provided by the servers 1102 and 1104 to rebalance the current portfolio toward the target optimal portfolio while minimizing the trade cost.

Alternatively, in another exemplary embodiment, the clients 1106 and 1108 may provide the servers 1102 and 1104 with computer-readable and computer-executable components or products under a particular condition, such as a license agreement. The computer-readable and/or computer-executable components or products may include those for generating a Michaud resampled efficient frontier, determining a target optimal portfolio on the Michaud resampled efficient frontier, determining one or more partial trades from a current portfolio, determining turnover (or trade cost), tracking error and rebalance probabilities associated with the partially rebalanced portfolios, and determining that a partially rebalanced portfolio is statistically optimal. The servers 1102 and 1104 may have a current portfolio, and may use the components or products provided by the clients 1106 and 1108 to rebalance the current portfolio toward the target optimal portfolio while minimizing the trade cost.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

Furthermore, the contents of all references, including patents, patent applications and publications, cited throughout this application are hereby expressly incorporated herein by reference in their entirety. The appropriate components and methods of those references may be used for the invention and embodiments thereof. Still further, the components and methods identified in the Background section are integral to this disclosure and may be used in conjunction with or substituted for components and methods described elsewhere in the disclosure within the scope of the invention.

What is claimed is:

1. A computer modeling system for modeling one or more partial trades to rebalance an investment portfolio, the computer modeling system comprising:
a memory having stored thereon computer-executable instructions for modeling one or more partial trades to rebalance an initial investment portfolio;
a processor operatively coupled to the memory and configured to:
programmatically receive, as a first input, a Michaud resampled efficient frontier of portfolios, the resampled efficient frontier programmatically generated based on input data corresponding to returns of a plurality of asset classes,
programmatically receive, as a second input, a first target optimal portfolio on the resampled efficient frontier of portfolios,
programmatically read the computer-executable instructions from the memory to model a first partial trade based on the initial portfolio toward the first target optimal portfolio to generate a first partially rebalanced portfolio, the first partial trade modeled to reduce a first optimality discrepancy associated with the initial portfolio relative to the first target optimal portfolio,
determine a first rebalance probability associated with the first partially rebalanced portfolio, and
determine that the first partially rebalanced portfolio is statistically optimal if the first rebalance probability satisfies a predefined rebalance probability criterion; and
a visual display device configured to display an indication that the first partially rebalanced portfolio is statistically optimal.

2. The computer modeling system of claim 1, wherein the processor is further configured to:
terminate modeling partial trades upon determining that the first partially rebalanced portfolio is statistically optimal.

3. The computer modeling system of claim 1, wherein the processor is further configured to:
programmatically read the computer-executable instructions from the memory to generate the resampled efficient frontier based on the input data corresponding to the returns of the plurality of asset classes.

4. The computer modeling system of claim 1, wherein the processor is further configured to:
programmatically read the computer-executable instructions from the memory to select the first target optimal portfolio on the resampled efficient frontier based on one or more predefined criteria.

5. The computer modeling system of claim 1, wherein the processor is further configured to:
programmatically read the computer-executable instructions from the memory to determine a first trading cost associated with the first partial trade.

6. The computer modeling system of claim 1, wherein the processor is further configured to:
programmatically read the computer-executable instructions from the memory to determine the first optimality discrepancy associated with the initial portfolio.

7. The computer modeling system of claim 1, wherein the processor is further configured to:
programmatically receive, as a third input, the predefined rebalance probability criterion.

8. The computer modeling system of claim 1, further comprising:
a database server for storing the initial portfolio comprising a plurality of assets, each asset characterized by a weighting coefficient.

9. The computer modeling system of claim 1, wherein the processor is further configured to:
determine that the first partially rebalanced portfolio is not statistically optimal if the first rebalance probability does not satisfy the predefined rebalance probability criterion.

10. The computer modeling system of claim 9, wherein, the processor is further configured to, upon determining that the first partially rebalanced portfolio is not statistically optimal:
programmatically read the computer-executable instructions from the memory to model a second partial trade based on the first partially rebalanced portfolio toward the target optimal portfolio to generate a second partially rebalanced portfolio, the second partial trade modeled to reduce a second optimality discrepancy associated with the first partially rebalanced portfolio;
determine a second rebalance probability associated with the second partially rebalanced portfolio; and
determine that the second partially rebalanced portfolio is statistically optimal if the second rebalance probability satisfies the predefined rebalance probability criterion.

11. The computer modeling system of claim 1, wherein the first partially rebalanced portfolio is different from the target optimal portfolio.

12. The computer modeling system of claim 1, wherein the processor is further configured to:
programmatically receive, as a third input, a second target optimal portfolio on the resampled efficient frontier of portfolios;
programmatically read the computer-executable instructions from the memory to model a second partial trade based on the initial portfolio toward the second target optimal portfolio to generate a second partially rebalanced portfolio, the second partial trade modeled to reduce a second optimality discrepancy associated with the initial portfolio relative to the second target optimal portfolio;
determine a second rebalance probability associated with the second partially rebalanced portfolio; and
determine that the second partially rebalanced portfolio is statistically optimal if the second rebalance probability satisfies the predefined rebalance probability criterion.

13. The computer modeling system of claim 12, wherein the processor is further configured to:
determine that a first trading cost associated with the first partial trade is lower than a second trading cost associated with the second partial trade; and
based on the determination, select, from the first and second partial trades, the first partial trade for rebalancing the initial portfolio toward the target optimal portfolio.

14. A computer-implemented method for modeling one or more partial trades to rebalance an investment portfolio, the method comprising:
programmatically receiving, as a first input, an initial investment portfolio comprising a plurality of assets, each asset characterized by a weighting coefficient;
programmatically receiving, as a second input, a Michaud resampled efficient frontier of portfolios, the resampled efficient frontier programmatically generated based on input data corresponding to returns of a plurality of asset classes;
programmatically receiving, as a third input, a first target optimal portfolio on the resampled efficient frontier of portfolios;
programmatically modeling, using a computing device having encoded thereon computer-executable instructions, a first partial trade based on the initial portfolio toward the first target optimal portfolio to generate a first partially rebalanced portfolio, the first partial trade modeled to reduce a first optimality discrepancy associated with the initial portfolio relative to the first target optimal portfolio;
determining, using the computing device, a first rebalance probability associated with the first partially rebalanced portfolio;
determining, using the computing device, that the first partially rebalanced portfolio is statistically optimal if the first rebalance probability satisfies a predefined rebalance probability criterion; and
displaying, using a visual display device, an indication that the first partially rebalanced portfolio is statistically optimal.

15. The computer-implemented method of claim 14, further comprising:
determining, using the computing device, that the first partially rebalanced portfolio is not statistically optimal if the first rebalance probability does not satisfy the predefined rebalance probability criterion.

16. The computer-implemented method of claim 15, further comprising, upon determining that the first partially rebalanced portfolio is not statistically optimal:
programmatically modeling, using the computing device, a second partial trade based on the first partially rebalanced portfolio toward the target optimal portfolio to generate a second partially rebalanced portfolio, the second partial trade modeled to reduce a second optimality discrepancy associated with the first partially rebalanced portfolio;
determining, using the computing device, a second rebalance probability associated with the second partially rebalanced portfolio; and
determining, using the computing device, that the second partially rebalanced portfolio is statistically optimal if the second rebalance probability satisfies the predefined rebalance probability criterion.

17. The computer-implemented method of claim 14, wherein the first optimality discrepancy is a tracking error relative to the target optimal portfolio.

18. The computer-implemented method of claim 14, further comprising:
conducting the first partial trade on the initial portfolio.

19. A non-transitory computer-readable storage medium configured to store instructions executable by a processing device, wherein execution of the instructions causes the processing device to implement a method comprising:
receiving, as a first input, an initial investment portfolio comprising a plurality of assets, each asset characterized by a weighting coefficient;
receiving, as a second input, a Michaud resampled efficient frontier of portfolios, the resampled efficient frontier generated based on input data corresponding to returns of a plurality of asset classes;
receiving, as a third input, a first target optimal portfolio on the resampled efficient frontier of portfolios;
modeling a first partial trade based on the initial portfolio toward the first target optimal portfolio to generate a first partially rebalanced portfolio, the first partial trade modeled to reduce a first optimality discrepancy associated with the initial portfolio relative to the first target optimal portfolio;
determining a first rebalance probability associated with the first partially rebalanced portfolio;
determining that the first partially rebalanced portfolio is statistically optimal if the first rebalance probability satisfies a predefined rebalance probability criterion; and
displaying an indication that the first partially rebalanced portfolio is statistically optimal.

20. The non-transitory computer readable storage medium of claim 19, wherein the first optimality discrepancy is a tracking error relative to the target optimal portfolio.
